(19) United States
(12) Patent Application Publication
(10) Pub. No.: US 2020/0364492 A1
(43) Pub. Date: Nov. 19, 2020

(54) GOAL-ORIENTED INTERACTIVE INSTRUCTIONAL SYSTEM BASED ON MACHINE LEARNING

(71) Applicant: ROOJOOM - WEB EXPERIENCES LTD., RAMAT-GAN (IL)

(72) Inventor: Or MEIROV, Yehud (IL)

(21) Appl. No.: 16/413,179

(22) Filed: May 15, 2019

(51) Int. Cl. G06K 9/62; G06N 5/04; G06N 20/00; G06F 9/451

(52) U.S. Cl. CPC G06K 9/623; G06K 9/6256; G06F 9/453; G06N 20/00; G06N 5/046

(57) ABSTRACT

There is provided a method of training a machine learning model adapted for guiding subjects to an instructional goal, the method comprising: a) executing, by a guidance system of a subject, a guidance behavior; and b) training the machine learning model, by a processor, with a training input comprising, at least, data indicative of a time of the execution of the guidance behaviour, data indicative of a degree of completion of the instructional goal for the subject—at a given time, and data indicative of subject-specific information; wherein the machine learning model is adapted to enable calculating a ranking derivative of an estimated likelihood of satisfaction of an instructional goal completion criterion, for subject-specific information, subsequent to execution of a given guidance behaviour, thereby facilitating executing, by a guidance system of a given subject, a guidance behavior selected according to the ranking.

### TECHNICAL FIELD

The presently disclosed subject matter relates to computer-based training systems and, more particularly, to training systems utilizing machine learning.

### BACKGROUND

Problems of safety training have been recognized in the conventional art and various techniques have been developed to provide solutions.

These systems tend to provide users uniform status information or realtime warnings, and users sometimes tend to ignore them.

### GENERAL DESCRIPTION

According to one aspect of the presently disclosed subject matter there is provided a method of training a machine learning model adapted for guiding subjects to an instructional goal, the method comprising:
a) executing, by a guidance system of a subject, a guidance behavior; and
b) training the machine learning model, by a processor, with a training input comprising, at least,
data indicative of a time of the execution of the guidance behaviour,
data indicative of a degree of completion of the instructional goal for the subject—at a given time, and
data indicative of subject-specific information;
wherein the machine learning model is adapted to enable calculating a ranking derivative of an estimated likelihood of satisfaction of an instructional goal completion criterion, for subject-specific information, subsequent to execution of a given guidance behaviour,
thereby facilitating executing, by a guidance system of a given subject, a guidance behavior selected according to the ranking.

In addition to the above features, the method according to this aspect of the presently disclosed subject matter can comprise one or more of features (i) to (xi) listed below, in any desired combination or permutation which is technically possible:
i. further comprising: repeating a)-b) until satisfaction of a training completion criterion.
ii. wherein the machine learning model is adapted to enable calculating a ranking derivative of an estimated likelihood of satisfaction of an instructional goal completion criterion—within an instructional goal time-constraint—for subject-specific information, subsequent to execution of a given guidance behavior.
iii. wherein the training input further comprises: data indicative of a subject completion status of the guidance behaviour.
iv. wherein the machine learning model comprises gradient boosting.
v. wherein the machine learning model comprises reinforcement learning.
vi. wherein the guidance system of the subject is integrated in a vehicle.
vii. wherein the guidance system of the subject is a personal computing device.

viii. wherein the guidance system of the subject is a telephone.
ix. wherein the guidance system of the subject is a personal assistant.
x. wherein the guidance behavior is executed in a chatbot application.
xi. wherein the guidance behavior is executed in a voice instruction.
xii. wherein the instructional goal comprises a subject being trained for a driving practice.
xiii. wherein the instructional goal comprises a subject being trained for a course-taking practice.
xiv. wherein the instructional goal comprises making a purchase.
xv. wherein the instructional goal comprises retaining a subscription.
According to another aspect of the presently disclosed subject matter there is provided a method for guiding subjects to an instructional goal, the method comprising:

executing, by a guidance system of a subject, a guidance behaviour, the guidance behaviour being selected, by a processor, according to, at least, a ranking derivative of an estimated likelihood of satisfaction of an instructional goal completion criterion, subsequent to execution of the guidance behaviour, for the subject-specific information of the subject, wherein the estimated likelihood of satisfaction is calculated utilizing a machine learning model trained according to the method disclosed above.

In addition to the above features, the method according to this aspect of the presently disclosed subject matter can comprise one or more of features (xii) to (xiv) listed below, in any desired combination or permutation which is technically possible:
xvi. wherein the ranking is calculated according to an arithmetic difference between:
an estimated likelihood of satisfaction of an instructional goal completion criterion, subsequent to execution of the guidance behavior, for the subject-specific information of the subject, and
an estimated likelihood of satisfaction of the instructional goal completion criterion, in absence of execution of the guidance behavior, for the subject-specific information of the subject.
xvii. wherein the guidance behavior is selected according to, at least, whether the ranking indicates that estimated likelihood of satisfaction of an instructional goal completion criterion, subsequent to execution of the guidance behavior, for the subject-specific information of the subject, is increased, as compared to a likelihood of satisfaction of the instructional goal completion criterion in absence of execution of the guidance behavior.
xviii. wherein the guidance behavior is selected according to, at least, one or more additional rankings, each additional ranking being derivative of an estimated likelihood of satisfaction of an additional instructional goal completion criterion, subsequent to execution of the guidance behavior, for the subject-specific information of the subject,
wherein each of the additional rankings is calculated utilizing the machine learning model.
According to another aspect of the presently disclosed subject matter there is provided a method of training a machine learning model for guiding subjects to an instructional goal, the method comprising:
a) selectively executing, by a guidance system of a subject, a guidance behaviour,
the guidance behavior being selected, by the processor, according to, at least, a ranking derivative of an estimated likelihood of satisfaction of an instrumental goal completion criterion, subsequent to execution of the guidance behavior, for the subject-specific information of the subject, wherein the ranking is calculated utilizing a machine learning model trained according to the method disclosed above,
wherein the ranking indicates that the estimated likelihood of satisfaction of an instrumental goal completion criterion subsequent to execution of the guidance behavior is decreased, as compared to likelihood of satisfaction of an instrumental goal completion criterion in absence of execution of the guidance behavior,
thereby giving rise to performing of exploratory execution of a negatively assessed guidance behavior; and
b) training the machine learning model, by a processor, with a training input comprising, at least,
data indicative of a time of the execution of the guidance behaviour,
data indicative of a degree of completion of the instructional goal for the subject—at a given time, and
data indicative of subject-specific information.

In addition to the above features, the method according to this aspect of the presently disclosed subject matter can comprise features (xv) listed below:
xix. wherein the selectively executing comprises:
generating a random number; and
according to whether the generated random number meets an exploratory execution threshold, performing exploratory execution of a negatively assessed guidance behavior.

According to one aspect of the presently disclosed subject matter there is provided a system comprising: a computerized device configured to perform a method of training a machine learning model adapted for guiding subjects to an instructional goal, the method comprising:
a) executing, by a guidance system of a subject, a guidance behavior; and
b) training the machine learning model, by a processor, with a training input comprising, at least,
data indicative of a time of the execution of the guidance behaviour,
data indicative of a degree of completion of the instructional goal for the subject—at a given time, and
data indicative of subject-specific information;
wherein the machine learning model is adapted to enable calculating a ranking derivative of an estimated likelihood of satisfaction of an instructional goal completion criterion, for subject-specific information, subsequent to execution of a given guidance behaviour,

thereby facilitating executing, by a guidance system of a given subject, a guidance behavior selected according to the ranking.

According to another aspect of the presently disclosed subject matter there is provided a non-transitory program storage device readable by a computer, tangibly embodying computer readable instructions executable by the computer to perform a method of training a machine learning model adapted for guiding subjects to an instructional goal, the method comprising:
c) executing, by a guidance system of a subject, a guidance behavior; and
d) training the machine learning model, by a processor, with a training input comprising, at least,
data indicative of a time of the execution of the guidance behaviour,
data indicative of a degree of completion of the instructional goal for the subject—at a given time, and
data indicative of subject-specific information;

wherein the machine learning model is adapted to enable calculating a ranking derivative of an estimated likelihood of satisfaction of an instructional goal completion criterion, for subject-specific information, subsequent to execution of a given guidance behaviour,

thereby facilitating executing, by a guidance system of a given subject, a guidance behavior selected according to the ranking.

Among the advantages of certain embodiments of the presently disclosed subject matter is the ability to train more efficiently and effectively train subjects in safety or other educational scenarios toward instructional goals.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an example interactive instruction system and a series of subject guidance systems with example components, according to some embodiments of the presently disclosed subject matter;

FIG. 2 illustrates a flow diagram describing an example process for training a machine learning model adapted for guiding subjects to an instructional goal, according to some embodiments of the presently disclosed subject matter;

FIG. 3 illustrates a flow diagram describing an example process for selecting guidance behaviors to guide a subject to one or more instructional goals, according to some embodiments of the presently disclosed subject matter; and

FIG. 4 illustrates an example guidance behavior ranking table, according to some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “representing”, “comparing”, “generating”, “assessing”, “matching”, “updating”, “calculating”, “estimating”, “correlating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the “processing and memory circuitry”, and “processor” disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

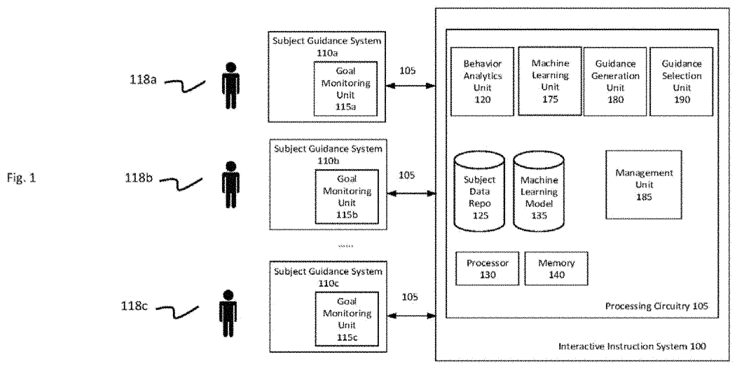

Bearing this in mind, attention is drawn to FIG. 1, which illustrates an example interactive instruction system 100 and a series of subject guidance systems (110a, 110b, 110c) with example components, according to some embodiments of the presently disclosed subject matter.

Interactive instruction system 100 can include a processing circuitry 105, which in turn can include—for example—a processor 130 operably coupled to a memory 140. Processor 130 can be, for example, a hardware-based electronic device with data processing capabilities, such as, for example, a general purpose processor, a specialized Application Specific Integrated Circuit (ASIC), one or more cores in a multicore processor etc. A processor 130 can also consist, for example, of multiple processors, multiple ASICs, a virtual processor, a cloud-based processor, combinations thereof etc.

A memory 140 can be, for example, any kind of volatile or non-volatile storage, and can include, for example, a single physical memory component or a plurality of physical memory components, virtualized or cloud-based memory etc. The memory 140 can be configured to, for example, store various data used in computation.

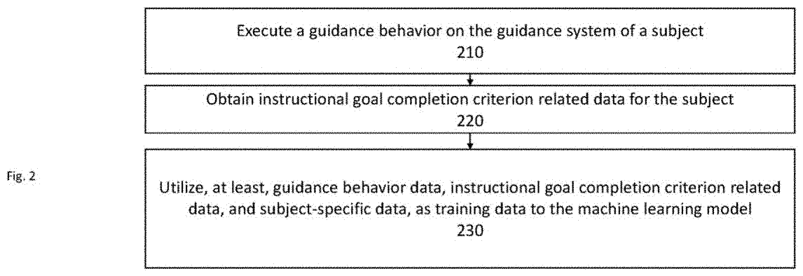

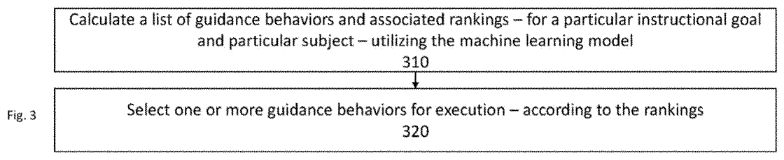

As will be further detailed hereinbelow with reference to FIGS. 2-3, the processing circuitry 105 can be configured to execute several functional modules in accordance with computer-readable instructions implemented on a non-transitory computer-readable storage medium. Such functional modules are referred to hereinafter as comprised in the processing and memory circuitry. These modules can include, for example, behavior analytics unit 120, machine learning unit 175, guidance generation unit 180, and guidance selection unit 190.

In some embodiments of the presently disclosed subject matter, interactive instruction system 100 is a system providing subjects with guidance towards accomplishing a particular instructional goal (or goals). Interactive instruction system 100 can provide guidance to a number of guidance subjects (118a, 118b, 118c) via a number of associated subject guidance systems (110a, 110b, 110c). The methods utilized by interactive instruction system 100 and associated subject guidance systems (110a, 110b, 110c) can be used in a wide range of safety, educational, or other scenarios.

By way of non-limiting example: interactive instruction system 100 can be configured for training drivers toward instructional goals including various safe driving practices. In such configurations, subject guidance systems (110a, 110b, 110c) can be integrated in a vehicle—for example: by being physically incorporated in a dashboard or other vehicle components, or by receiving data from in-vehicle sensors and monitors. Such subject guidance systems (110a, 110b, 110c) can (by way of non-limiting example) include facilities such as:
a realtime navigation system that displays a map with the vehicle's current location in combination with other information such as street and landmark data
an audio system that uses sounds to indicate, for example, navigation instructions or warning events
icons on a dashboard or on a augmented-reality enabled transparent windshield display

A interactive instruction system 100 configured for training subjects (drivers) in safe driving practices can have, for example, instructional goals such as the following:
a) training a driver to maintain a safe distance between the driver's vehicle and the vehicle immediately ahead of it.

For this instructional goal, there can be a completion criterion, such as, (for example): subject maintains a distance of least 2 seconds traveling time for at least 90% of driving time, for both speeds below 50 km/h and speeds above 50 km/h.
For this instructional goal, there can be a time constraint, such as (for example) 4 weeks as measured from institution of the execution of the first guidance behavior for the instructional goal. The time constraint can be used to indicate the time for measurement of success or lack of success of training the subject toward the instructional goal, as will be described hereinbelow.
b) training a driver to properly maintain the vehicle.
For this instructional goal, there can be a completion criterion, such as, (for example): tire pressure, oil level are at safe levels for 90% of driving time, and periodic maintenance is performed very 20000 km.
For this instructional goal, there can be a time constraint, such as (for example) 18 months.

c) etc.

For instructional goal a), there can be a number of available guidance behaviors such as, for example, the following:
a) performing an in-vehicle on-screen request asking if the driver would like to receive a realtime audio notification when the following distance is too short—and then performing the audio notification
b) showing the driver—at ignition-on time—his/her historical following distance with comparisons to recommended distances.
c) on days with poor weather conditions, making an audio announcement that due to slippery roads following distances should be increased.
d) inviting the user to receive a link to view a safety video on his/her0 mobile phone. For this guidance behavior, the user can actually view the video or decide not to view the video. In such cases the guidance behavior is termed as having a completion status (e.g. if the user watched the video then the guidance behavior is completed, otherwise it is not)
etc.

Subject guidance systems (110a, 110b, 110c) can include goal monitoring units (115a, 115b, 115c). Goal monitoring units (115a, 115b, 115c) can collect information pertaining to whether or not instructional goals have been completed i.e. data indicative of satisfaction of the completion criteria of these goals. In the case of an in-vehicle training system, goal monitoring units (115a, 115b, 115c) can collect vehicle use information such as, for example, historical vehicle speeds and historical following distances (as monitored by a vehicle-based sensor). The goal monitoring units (115a, 115b, 115cpg,17 ) can also collect other vehicle status information for determining status of other instructional goals. This status information can include (for example) tire pressure, oil level, historical positioning in lanes, whether signaling preceded turns etc.

Other configurations of interactive instruction system 100 can train subjects to different instructional goals, and —accordingly—these configurations can utilize subject guidance systems (110a, 110b, 110c) that are tailored to those goals.

By way of non-limiting example: in a configuration for an online classroom or online course scenario (such as teaching students a non-native language), instructional goals can include exhibiting skills such as proper pronunciation, or exhibiting course-taking practices such as completing assignments on time. In some such configurations, subject guidance systems (110a, 110b, 110c) can be, for example, personal computing devices such as laptops or mobile devices with headsets.

By way of non-limiting example: in a configuration for a commercial purpose instructional goals can include, for example, making a purchase or retaining a subscription to an online service. In, for example, such configurations, subject guidance systems (110a, 110b, 110c) can be, for example, publicly located interactive information display devices with touch screens, or personal computing devices.

In some embodiments of the presently disclosed subject matter, subject guidance systems (110a, 110b, 110c) can be personal devices such as telephones, personal computing devices, and personal assistant devices (such as, for example, the Alexa device manufactured by amazon.com Inc.). In some such embodiments, guidance behaviors can be voice instructions provided by—for example—an interactive voice response (IVR) system that is integrated with interactive instructional system (100). In some embodiments of the presently disclosed subject matter guidance behaviors can be executed in a chatbot application of a personal device. Voice instructions, chatbot instructions etc.—when used for executing guidance behaviors—are herein referred to as guidance behavior formats.

In some embodiments of the presently disclosed subject matter, subject guidance systems (110a, 110b, 110c) can be personal assistant devices

Subject guidance systems (110a, 110b, 110c) can be operably connected to interactive instruction system 100 via network connection 105. Network connection 105 can be, for example, any kind of wired or wireless network connection, such as a cellular data connection, Ethernet, etc.

In some embodiments of the presently disclosed subject matter, interactive instruction system 100 maintains a structured sequence of instructional goals—divided into stages—so that in an initial stage the subject is trained according to “novice” instructional goals, and later on according to “experienced” instructional goals. By way of non-limiting example, for a novice driver, instructional goals might include maintaining a constant following distance, whereas for an “experienced” driver, instructional goals might include avoidance of distracted driving.

Subject data repository 125 can be a database or data repository (for example in volatile or non-volatile memory or storage) located, for example, in the processing circuitry (as in FIG. 1) or remotely, in a cloud service etc. Subject data repository 125 can maintain, for example, subject-specific information such as demographic data of subjects (such as age, physical location, education, etc.), goal-pertinent data (such as type of vehicle driven, skill-level etc.), subject-configured data (e.g. settings he/she has entered into a subject guidance system), historical values of these data, etc. Data can be loaded into the subject data repository 125, by, for example, management unit 185.

Machine-learning model 135 can be a database or data repository (for example in volatile or non-volatile memory or storage) located, for example, in the processing circuitry (as in FIG. 1) or remotely, in a cloud service etc. Machine-learning model 135 can, for example, store accumulated results of the example machine-learning process described hereinbelow, with reference to FIG. 2.

Machine-learning model 135 can be configured, for example, to enable calculating a ranking indicative of an estimated likelihood of satisfaction of an instructional goal completion criterion, for subject-specific information, subsequent to execution of a given guidance behavior.

In some embodiments, machine learning model 135 can be configured to enable predictive classification of input subject-specific information and specific guidance behaviors—to predict the satisfaction of the instructional goal completion criteria of the different instructional goals, within instructional goal-specific time constraints.

By way of non-limiting example: in a configuration where interactive instructional system 100 is training a subject 110a toward the instructional goal of maintaining a safe following distance when driving (with the instructional goal completion criterion and instructional goal time-constraint described above), then the machine learning model can be configured to predictively classify whether input data consisting of the subject's subject-specific information and a guidance behavior selected from the example guidance behaviors described hereinabove will result in satisfaction of the instructional goal completion criterion (e.g. the subject maintaining correct following distance as described hereinabove) within the time indicated by the instructional goal-specific time constraint (e.g. 4 weeks).

In some embodiments, this predictive classification can be binary (i.e. a 0/1 value indicating whether the inputs are estimated to result/not result in satisfaction of the completion criterion within the time constraint). In other embodiments, the predictive classification can result in a numeric probability value (e.g. a value between 0 and 1 denoting an estimated likelihood that the guidance behavior will result in satisfaction of the instructional goal completion criterion within the time indicated by the instructional goal-specific time constraint).

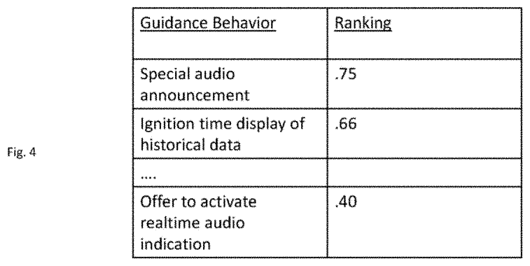

A guidance behavior ranking can be calculated from the results of predictive classification. Calculation of guidance behavior ranking can be performed, by—for example—guidance generation unit 180, as described hereinbelow, with reference to FIGS. 3-4.

Behavior analytics unit 120 can be a functional module—comprised, for example, in the processing circuitry—that obtains, for example, data indicative of satisfaction of instructional goal completion criteria from—for example—various goal monitoring unit instances (115a, 115b, 115c).

Behavior analytics unit 120 can also obtain data indicative of guidance that has been executed on the various subject guidance system instances (110a, 110b, 110c). It can obtain this data from, for example, subject guidance system instances (110a, 110b, 110c) via network connection 105. Alternatively, it can obtain the data from guidance selection unit 190 (which in some embodiments determines the guidance behaviors to execute). Behavior analytics unit 120 can obtain subject-specific information such as, for example, demographic, goal-specific, or other data stored in subject data repository 125.

Behavior analytics unit 120 can provide its received input data to machine learning unit 175.

Machine learning unit 175 can be a functional module—comprised, for example, in the processing circuitry—that receives training data generated by behavior analytics unit 120 and performs machine learning so as to enable calculating a ranking derivative of an estimated likelihood of satisfaction of an instructional goal completion criterion, for subject-specific information, subsequent to execution of a given guidance behavior. Machine learning unit 175 can implement, for example, any kind of suitable machine learning method, such as gradient boosting, neural networks, reinforcement learning, etc. Machine learning unit 175 can store its accumulated learning data—for example—in machine learning model 135.

Guidance generation unit 180 can be a functional module—comprised, for example, in the processing circuitry—that calculates a list of guidance behaviors (for example: utilizing a list of guidance behaviors supported by interactive instruction system 100 for the particular instructional goal) for possible execution on the subject guidance system (e.g 110a) of a particular subject.

Guidance generation unit 180 can utilize data from machine learning model 135 to, for example, generate a data structure derivative of a ranking table in which the rankings are derivative of an estimated likelihood of satisfaction of an instructional goal completion criterion, for subject-specific information, subsequent to execution of a given guidance behavior.

It is noted that in some cases, a particular guidance behavior might have been learned to be ineffective for a particular subject, or even to have a negative effect on the likelihood of satisfaction of an instruction goal completion criterion. For example, it might be learned that for particular subjects, a specific guidance behavior tends to be ignored by certain subjects, or even tends to encourage contrarian practices which reduce the likelihood of satisfaction of an instruction goal completion criterion. Such guidance behaviors are herein termed negatively assessed guidance behaviors. A guidance behavior that has been learned to have a positive effect on the likelihood of satisfaction of an instruction goal completion criterion is termed a positively-assessed guidance behavior.

In some embodiments, rankings in the table can be indicative of whether the estimated likelihood of satisfaction of an instructional goal completion criterion is increased—as compared to the estimated likelihood of satisfaction of the instructional goal completion criterion in absence of execution of the guidance behavior. An example of such a table is illustrated below, with reference to FIG. 4.

Management Unit 185 can, for example, instruct guidance generation unit 180 to generate a guidance behavior ranking table for a particular subject (118a, 118b, 118c).

Guidance selection unit 190 can select one or more guidance behaviors from a guidance behavior ranking table that was generated for a particular subject (118a, 118b, 118c) and can cause the guidance behaviors to be executed on the appropriate subject guidance system (110a, 110b, 110c).

Guidance selection unit 190 can, for example, select guidance behaviors according to the rankings in the table. In some embodiments, guidance selection unit 190 can examine the ranking of the highest ranking guidance behavior in the table, and select the guidance behavior if the ranking indicates that the estimated likelihood of satisfaction of an instructional goal completion criterion, subsequent to execution of the given guidance behavior, for the particular subject is higher than in the absence of execution of the guidance behavior for the subject.

In some embodiments, guidance selection unit 190 can, on an exploratory basis select a guidance behavior for execution even when the ranking indicates that the estimated likelihood of satisfaction of an instructional goal completion criterion subsequent to execution of the given guidance behavior for the particular subject is lower than in the absence of execution of the guidance behavior for the subject.

Details of guidance behavior selection are described hereinbelow, with reference to FIGS. 3-4.

Guidance selection unit 190 can execute guidance behaviors by, for example, sending instructions to the appropriate subject guidance system (110a, 110b, 110c) via network connection 105.

Management unit 185 can be a functional module—comprised, for example, in the processing circuitry—that performs management tasks such as, for example receiving, for example, subject data (via for example a screen and keyboard) and stores the data to subject data repository 125. Management unit 185 can also, for example, determine when guidance behaviors should be generated and executed for particular subjects (118a, 118b, 118c).

It is noted that the teachings of the presently disclosed subject matter are not bound by the interactive instruction system and subject guidance systems described with reference to FIG. 1. Equivalent and/or modified functionality can be consolidated or divided in another manner and can be implemented in any appropriate combination of software with firmware and/or hardware and executed on a suitable device. The interactive instruction system and subject guidance systems can each be a standalone entity, or integrated, fully or partly, with other entities—via a network or other means.

Attention is now directed to FIG. 2, which illustrates a flow diagram describing an example process for training a machine learning model adapted for guiding subjects to an instructional goal, according to some embodiments of the presently disclosed subject matter.

The example process illustrated in FIG. 2 is hereforward termed a periodic learning process. The flow diagram of FIG. 2 illustrates the periodic learning process for a single subject (e.g. 118a). In some embodiments the periodic learning process is executed in parallel for various subjects in the system, thus enabling learning to be conducted over a wide variety of subjects.

In some embodiments of the presently disclosed subject matter, interactive instruction system 100 can repeatedly execute the periodic learning process at least until the machine learning model is sufficiently trained—as indicated by satisfaction of a training completion criterion. In some embodiments, a training completion criterion can be, for example, training with a particular number of datasets eg. 50000. In some embodiments, a training completion criterion can be, for example, success in an A/B testing environment—that is to say that subjects for whom guidance behaviours were selected according to the machine learning model attain completion criteria of instructional goals at a significantly higher rate than subjects who are guided according to random selection of guidance behaviours.

In some embodiments, the interactive instruction system 100 can continue to execute the periodic learning process following satisfaction of a training completion criterion—for example: to ensure that the machine learning model remains up-to-date and consistent with changes in subject behavior that might result from—for example—changes in external factors.

To begin a periodic learning process, interactive instruction system 100 (for example: guidance selection unit 190) can select a guidance behavior, and execute (210) the guidance behavior on the subject guidance system (e.g. 110a) of a subject (e.g. 118a).

In some embodiments of the presently disclosed subject matter, after initial system activation, interactive instruction system 100 (for example: guidance selection unit 190) selects guidance behaviors for execution according to, for example, fixed initial rules (i.e. the machine learning model is not used after initial system activation to determine guidance behaviors because the model has not yet been trained). In such embodiments, after the machine learning model has been trained (e.g. a training completion criterion has been satisfied), interactive instruction system 100 (for example: guidance selection unit 190) can switch to selecting guidance behaviors according to their ranking as calculated using the machine learning model (for example: as described in more detail hereinbelow with reference to FIGS. 3-4).

The guidance behavior can be selected from a group of guidance behaviors maintained by interactive instruction system 100 for executing on subject guidance systems (e.g. 110a) to guide subjects (e.g. 118a) toward, for example, one or more instructional goals that are in effect for the subject (e.g. 118a). Non-limiting examples of instructional goals and guidance behaviors are described hereinabove, with reference to FIG. 1.

In some embodiments, more than one guidance behavior can be selected and executed for a subject. In such embodiments, the guidance behaviors can be selected, for example, simultaneously or sequentially. In such embodiments, the guidance behaviors can be executed on the subject guidance system (e.g. 110a) of a subject (e.g. 118a), for example, simultaneously or sequentially.

After the execution of one or more guidance behaviors for a subject (e.g. 118a), interactive instruction system 100 (for example: behavior analytics unit 120) can obtain (220) data indicative of satisfaction of a completion criterion of the instructional goal for the subject—at a given time.

In some embodiments, interactive instruction system 100 (for example: behavior analytics unit 120) can obtain this data by—for example—communicating with the goal monitoring unit (e.g. 115a) of the subject (e.g. 118a) via network connection 105. In this case, the given time associated with the data can the time of the receiving of the data.

As described hereinabove with reference to FIG. 1, the specific data that is tracked by—for example—a goal monitoring unit (e.g. 115a) is dependent on the configuration of interactive instruction system 100. Non-limiting examples of data indicative of satisfaction of a completion criterion of an instructional goal are described hereinabove, with reference to FIG. 1.

In some embodiments, interactive instruction system 100 (for example: behavior analytics unit 120) can obtain data indicative of satisfaction of completion criteria for multiple instructional goals.

Interactive instruction system 100 (for example: machine learning unit 175) can then train (240) the machine learning model 135 with input data including, at least:
data indicative of a time of the execution of the guidance behaviour or behaviours for the subject. This information can be determined for example by interactive instruction system 100 (for example: machine learning unit 175) at the time of execution of the guidance behaviour. Alternatively, this information can be retrieved from with the goal monitoring unit (e.g. 115a) of the subject (e.g. 118a) via network connection 105.
the obtained data indicative of the satisfaction of the completion criterion of the instructional goal for the subject—at a given time.
data indicative of subject-specific information of the subject. Subject-specific information can be obtained, for example, from subject data repository 125. The specific subject-specific information used in training can be a subset of the subject-specific information (eg. certain demographic data) that has, for example, been empirically determined to be correlated with satisfaction of completion criteria of instructional goals. The subject-specific information used for training can include—for example—historical data (such as data indicative of his/her previous driving behaviour) or data that the subject has entered into the system (such as information about personal instructional preferences).

It is noted that this training of the machine learning model 135 with the input data as described above need not take place in a single operation. For example, interactive instruction system 100 for example: behavior analytics unit 120) can first train the machine learning model 135 with the data indicative of a time of the execution of the guidance behavior and data informative of subject specific information (for example: immediately after the guidance behavior execution), and then subsequently train the machine learning model 135 with the data indicative of the satisfaction of the completion criterion. (e.g. when data from goal monitoring unit 115a is received).

In this manner, machine learning model 135 can estimate the efficacy of the executed guidance behaviors in bringing about the instructional goals according to, for example, subject-specific data such as demographics. For example, machine learning model 135 might learn that certain guidance behaviors are more effective with drivers in particular age brackets, or geographic locations, or in particular types of vehicles.

It is noted that the teachings of the presently disclosed subject matter are not bound by the flow diagram illustrated in FIG. 2, the illustrated operations can occur out of the illustrated order. For example, operations 220 and 230 shown in succession can be executed substantially concurrently or in the reverse order. It is also noted that whilst the flow chart is described with reference to elements of the system of FIG. 1, this is by no means binding, and the operations can be performed by elements other than those described herein.

Attention is now directed to FIG. 3, which illustrates a flow diagram describing an example process for selecting guidance behaviors to guide a subject to one or more instructional goals, according to some embodiments of the presently disclosed subject matter.

The guidance behavior selection process described in FIG. 3 can be executed by interactive instructional system 100 (for example: guidance generation unit 180) as part of guidance behavior selection (210) conducted in the periodic learning process described hereinabove, with reference to FIG. 2. In particular, the guidance behavior selection process described in FIG. 3 can be used following training of the machine learning model 135.

Interactive instructional system 100 (for example: guidance generation unit 180) can utilize machine learning model 135 to calculate (310) a list of guidance behaviors and associated rankings indicative of an estimated likelihood of satisfaction of a completion criterion—for a particular instructional goal and for a particular subject. A description of an example method of calculation of the rankings, and an example representation of such a list of guidance behaviors and associated rankings—according to some embodiments—is described hereinbelow, with reference to FIG. 4.

It is noted that in some embodiments, the rankings can indicate whether a specific guidance behavior has a positive effect—for the subject—in attainment of an instructional goal), or a negative effect (i.e. that a guidance behavior was learned to actually have a negative impact upon the attainment of an instructional goal, for the subject-specific data).

Interactive instructional system 100 (for example: guidance generation unit 180) can next select (320) one or more guidance behaviors for execution, in according with the rankings in attaining one or more instructional goals.

In some embodiments, interactive instructional system 100 (for example: guidance generation unit 180) maintains a single active instructional goal for a subject at a given time. In such embodiments, interactive instructional system 100 (for example: guidance generation unit 180) can select, for example, the guidance behavior with the highest ranking—for execution on the guidance system of the subject. Alternatively, interactive instructional system 100 (for example: guidance generation unit 180) can select, for example, the top 2 or top 3 guidance behaviors according to their rankings.

In some embodiments interactive instructional system 100 (for example: guidance generation unit 180) maintains several active instructional goals for the subject at a given time. In some such embodiments, interactive instructional system 100 (for example: guidance generation unit 180) can select the guidance behavior with the highest ranking—for the instructional goal that is regarded as the highest priority.

In some such embodiments, interactive instructional system 100 (for example: guidance generation unit 180) can—upon determining that there are no positively-assessed guidance behaviors for the first instructional goal—select the guidance behavior with the highest ranking—for the instructional goal that is regarded as the second highest priority. Many other options for selecting guidance behaviors are possible, as will be apparent to one skilled in the art.

In some embodiments, when selecting guidance behaviors according to the methods described hereinabove (or other methods), interactive instructional system 100 (for example: guidance generation unit 180) refrains from selecting any guidance behavior that is a negatively-assessed guidance behavior.

However, interactive instructional system 100 (for example: guidance generation unit 180) can periodically (e.g. upon a randomly selected proportion of periodic learning cycles) select for execution—in a periodic learning process—a guidance behavior that has been negatively assessed for a particular subject. In so doing, interactive instructional system 100 (for example: guidance generation unit 180) can on an ongoing basis improve the ranking information in the machine learning model 135 and ensure that the machine learning model 135 remains up-to-date and effective. This method is herein termed exploratory execution of a negatively assessed guidance behavior.

By way of non-limiting example, interactive instructional system 100 (for example: guidance generation unit 180) can—before selecting a guidance behavior in a periodic learning cycle—generate a random number within a certain number range. A pseudorandom number is herein regarded as a random number. If the generated random number meets an exploratory execution threshold (by way of non-limiting example: if the number range were 0-15, the exploratory execution threshold could be 14) interactive instructional system 100 (for example: guidance generation unit 180) can then perform exploratory execution of a negatively assessed guidance behavior, and accordingly select a negative assessed guidance behavior according to its ranking.

It is noted that the teachings of the presently disclosed subject matter are not bound by the flow diagram illustrated in FIG. 3. It is also noted that whilst the flow chart is described with reference to elements of the system of FIG. 1, this is by no means binding, and the operations can be performed by elements other than those described herein.

Attention is now directed to FIG. 4, which illustrates an example guidance behavior ranking table, according to some embodiments of the presently disclosed subject matter.

The example guidance behavior ranking table illustrated in FIG. 4 can represent a logical guidance behavior ranking table generated by interactive guidance system 100 (for example: guidance generation unit 180) for a particular instructional goal and a particular subject, utilizing machine learning model 135. It will be clear to one skilled in the art that a table such as the one illustrated in FIG. 4 can be implemented in various data structure or database formats, and can include more data fields, fewer data fields, or different data fields from the structure illustrated.

The example guidance behavior ranking table can pertain to a particular instructional goal (in FIG. 4. the example goal is: “maintaining a safe vehicular following distance”; the completion criterion and time constraints can be as described hereinabove, with reference to FIG. 1), and to a particular subject (e.g. 118a). The example guidance behavior ranking table can consist of a number of rows, where each row can pertain to a guidance behavior that can be executed by interactive instructional system 100 (e.g. “offer to activate realtime audio indication” guidance behavior as described above with reference to FIG. 1). A row can include a “ranking”—which can be, for example, derivative of an estimated likelihood of satisfaction of the completion criterion subsequent to the system execution of the guidance behavior on his/her subject guidance system.

In some embodiments, machine learning module 135—subsequent to training—enables interactive guidance system 100 (for example: guidance generation unit 180) to perform predictive classification of subject-specific information inputs—resulting in, for example, a value (for example: between 0 and 1), that is indicative of an estimated likelihood of satisfaction of the completion criterion of the instructional goal within the instructional goal time constraint—subsequent to the execution of the guidance behavior. In some embodiments, interactive guidance system 100 (for example: guidance generation unit 180) can further perform predictive classification of subject-specific information inputs—resulting in a number (for example: between 0 and 1), that is indicative of an estimated likelihood of satisfaction of the completion criterion of the instructional goal within the instructional goal time constraint—in absence of the execution of the guidance behavior.

In some such embodiments, a ranking can be calculated according to the arithmetic difference between this estimated likelihood of satisfaction of the completion criterion of the instructional goal following the execution of the guidance behavior and this estimated likelihood of satisfaction of the completion criterion of the instructional goal in absence of execution of the guidance behavior.

In some such embodiments, the ranking of efficacy can be calculated according to the formula:

$$ranking = \frac{1}{1 + {α}^{2 * \frac{p 1 - p 0}{p 0}}}$$

where p1 denotes the estimated likelihood of satisfaction of the instructional goal completion criterion following the execution of the guidance behavior, and p0 denotes the estimated likelihood of satisfaction of the instructional goal completion criterion if the guidance behavior is not executed. α (“alpha”) denotes a value for randomization—which can be for example 0.5. It is noted that when this formula is utilized, rankings range between 0 and 1. It is further noted when this formula is utilized, a ranking value greater than 0.5 indicates that the guidance behavior is positively assessed (i.e. increases the likelihood of instructional goal completion), and that a ranking value of less than 0.5 indicates that the guidance behavior is negatively assessed (i.e. decreases the likelihood of instructional goal completion).

In some embodiments, the ranking derivative of the estimated likelihood of satisfaction of the instructional goal completion criterion can be identical with the estimated likelihood.

For a particular subject, interactive guidance system 100 (for example: guidance generation unit 180) can generate multiple guidance behavior ranking tables i.e. a distinct table per instructional goal per subject.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method of training a machine learning model adapted for guiding subjects to an instructional goal,
the method comprising:
a) executing, by a guidance system of a subject, a guidance behavior; and
b) training the machine learning model, by a processor, with a training input comprising, at least,
data indicative of a time of the execution of the guidance behaviour,
data indicative of a degree of completion of the instructional goal for the subject—at a given time, and
data indicative of subject-specific information;
wherein the machine learning model is adapted to enable calculating a ranking derivative of an estimated likelihood of satisfaction of an instructional goal completion criterion, for subject-specific information, subsequent to execution of a given guidance behaviour,
thereby facilitating executing, by a guidance system of a given subject, a guidance behavior selected according to the ranking.

2. The method of claim 1, further comprising:
repeating a)-b) until satisfaction of a training completion criterion.

3. The method of claim 1, wherein the machine learning model is adapted to enable calculating a ranking derivative of an estimated likelihood of satisfaction of an instructional goal completion criterion—within an instructional goal time-constraint—for subject-specific information, subsequent to execution of a given guidance behavior.

4. The method of claim 1, wherein the training input further comprises:
data indicative of a subject completion status of the guidance behaviour.

5. A method for guiding subjects to an instructional goal, the method comprising:
executing, by a guidance system of a subject, a guidance behaviour, the guidance behaviour being selected, by a processor, according to, at least, a ranking derivative of an estimated likelihood of satisfaction of an instructional goal completion criterion, subsequent to execution of the guidance behaviour, for the subject-specific information of the subject, wherein the estimated likelihood of satisfaction is calculated utilizing a machine learning model trained according to the method of claim 1.

6. The method of claim 5, wherein the ranking is calculated according to an arithmetic difference between:
an estimated likelihood of satisfaction of an instructional goal completion criterion, subsequent to execution of the guidance behavior, for the subject-specific information of the subject, and
an estimated likelihood of satisfaction of the instructional goal completion criterion, in absence of execution of the guidance behavior, for the subject-specific information of the subject.

7. The method of claim 6, wherein the guidance behavior is selected according to, at least, whether the ranking indicates that estimated likelihood of satisfaction of an instructional goal completion criterion, subsequent to execution of the guidance behavior, for the subject-specific information of the subject, is increased, as compared to a likelihood of satisfaction of the instructional goal completion criterion in absence of execution of the guidance behavior.

8. The method of claim 7, wherein the guidance behavior is selected according to, at least, one or more additional rankings, each additional ranking being derivative of an estimated likelihood of satisfaction of an additional instructional goal completion criterion, subsequent to execution of the guidance behavior, for the subject-specific information of the subject,
wherein each of the additional rankings is calculated utilizing the machine learning model.

9. A method of training a machine learning model for guiding subjects to an instructional goal, the method comprising:
a) selectively executing, by a guidance system of a subject, a guidance behaviour,
the guidance behavior being selected, by the processor, according to, at least, a ranking derivative of an estimated likelihood of satisfaction of an instrumental goal completion criterion, subsequent to execution of the guidance behavior, for the subject-specific information of the subject, wherein the ranking is calculated utilizing a machine learning model trained according to the method of claim 1,
wherein the ranking indicates that the estimated likelihood of satisfaction of an instrumental goal completion criterion subsequent to execution of the guidance behavior is decreased, as compared to likelihood of satisfaction of an instrumental goal completion criterion in absence of execution of the guidance behavior,
thereby giving rise to performing of exploratory execution of a negatively assessed guidance behavior; and
b) training the machine learning model, by a processor, with a training input comprising, at least,
data indicative of a time of the execution of the guidance behaviour, data indicative of a degree of completion of the instructional goal for the subject—at a given time, and
data indicative of subject-specific information.

10. The method of claim 9, wherein the selectively executing comprises:
generating a random number; and
according to whether the generated random number meets an exploratory execution threshold, performing exploratory execution of a negatively assessed guidance behavior.

11. The method of claim 1, wherein the machine learning model comprises a machine learning method selected from the group consisting of: gradient boosting, and reinforcement learning.

12. The method of claim 1, wherein the guidance system of the subject is integrated in a vehicle.

13. The method of claim 1, wherein the guidance system of the subject is a personal device selected from the group consisting of: personal computing device, personal assistant, and telephone.

14. The method of claim 13, wherein a guidance behavior is executed in an execution format selected from the group consisting of: chatbot application, and voice instruction.

15. The method of claim 1, wherein the instructional goal comprises a subject being trained for a driving practice.

16. The method of claim 1, wherein the instructional goal comprises a subject being trained for a course-taking practice.

17. The method of claim 1, wherein the instructional goal comprises making a purchase.

18. The method of claim 1, wherein the instructional goal comprises retaining a subscription.

19. A system comprising a processing circuitry configured to perform a method of training a machine learning model adapted for guiding subjects to an instructional goal,
the method comprising:
a) executing, by a guidance system of a subject, a guidance behavior; and
b) training the machine learning model, by a processor, with a training input comprising, at least,
data indicative of a time of the execution of the guidance behaviour,
data indicative of a degree of completion of the instructional goal for the subject—at a given time, and
data indicative of subject-specific information;
wherein the machine learning model is adapted to enable calculating a ranking derivative of an estimated likelihood of satisfaction of an instructional goal completion criterion, for subject-specific information, subsequent to execution of a given guidance behaviour,
thereby facilitating executing, by a guidance system of a given subject, a guidance behavior selected according to the ranking.

20. A non-transitory computer readable medium comprising instructions that, when executed by a computer, cause the computer to perform a method of training a machine learning model adapted for guiding subjects to an instructional goal,
the method comprising:
a) executing, by a guidance system of a subject, a guidance behavior; and
b) training the machine learning model, by a processor, with a training input comprising, at least,
data indicative of a time of the execution of the guidance behaviour,
data indicative of a degree of completion of the instructional goal for the subject—at a given time, and
data indicative of subject-specific information;
wherein the machine learning model is adapted to enable calculating a ranking derivative of an estimated likelihood of satisfaction of an instructional goal completion criterion, for subject-specific information, subsequent to execution of a given guidance behaviour,
thereby facilitating executing, by a guidance system of a given subject, a guidance behavior selected according to the ranking.
